(19) United States
(12) Patent Application Publication
(10) Pub. No.: US 2023/0195802 A1
(43) Pub. Date: Jun. 22, 2023

(54) DATA PROCESSING METHOD AND APPARATUS

(71) Applicant: BEIJING SOGOU TECHNOLOGY DEVELOPMENT CO., LTD., Beijing (CN)

(72) Inventor: Hang ZHAO, Beijing (CN)

(73) Assignee: BEIJING SOGOU TECHNOLOGY DEVELOPMENT CO., LTD., Beijing (CN)

(21) Appl. No.: 18/168,269

(22) Filed: Feb. 13, 2023

Related U.S. Application Data
(63) Continuation of application No. PCT/CN2021/103566, filed on Jun. 30, 2021.

(30) Foreign Application Priority Data
Dec. 4, 2020 (CN) 202011406478.6

(51) Int. Cl. G06F 16/906; G06F 16/901; G06F 16/9538

(52) U.S. Cl. CPC G06F 16/906; G06F 16/9024; G06F 16/9538

(57) ABSTRACT

An apparatus and method for data processing includes determining a search keyword according to a search statement input by a user; determining a first graph entity library corresponding to a category to which the search keyword belongs; determining, according to an association relationship between graph entity libraries of a plurality of categories, a category of a graph entity library associated with the first graph entity library, and constructing a first set, the first set including at least one graph entity library which has an association relationship with the first graph entity library, and the association relationship between the graph entity libraries is established according to a search demand of a user; and displaying, after the first set is constructed, each graph entity library included in the first set by using the search keyword as a center.

### CROSS REFERENCE TO RELATED APPLICATIONS

This application is a continuation of PCT/CN2021/103566 filed on Jun. 30, 2021 and claims priority to Chinese Patent Application No. 202011406478.6 filed on Dec. 4, 2020 with the National Intellectual Property Administration, PRC, the contents of each of which being incorporated by reference herein in their entireties.

### FIELD

The embodiments of the disclosure relate to the field of data processing and particularly relates to a data processing method and apparatus.

### BACKGROUND

With the development of network technology, users may use the network to obtain what they want to obtain. In an example, a user may input a search statement in an input region provided by a search engine, and the search engine provides the user with a search result corresponding to the search statement.

How to provide the users with search results that meet demands of the users is an urgent problem to be solved currently.

### SUMMARY

The technical problem to be solved in the present disclosure is how to provide users with search results that meet demands of the users, and a data processing method and apparatus are provided.

According to an aspect of one or more embodiments, there is provided a method for data processing, the method including: determining a search keyword according to a search statement input by a user; determining a first graph entity library corresponding to a category to which the search keyword belongs; determining, according to an association relationship between graph entity libraries of each category, a category of a graph entity library associated with the first graph entity library, constructing a first set, the first set comprising at least one graph entity library which has an association relationship with the first graph entity library, pre-constructing the graph entity libraries of a plurality of categories, establishing the association relationship between the graph entity libraries of the each category according to a search demand of the user; and displaying each graph entity library comprised in the first set by using the search keyword as a center.

According to other aspects of one or more embodiments, there is also provided an apparatus and non-transitory computer readable medium consistent with the method.

### BRIEF DESCRIPTION OF THE DRAWINGS

To describe the technical solutions in the example embodiments of the disclosure more clearly, the following briefly introduces the accompanying drawings required for describing the example embodiments. The accompanying drawings in the following description show merely some embodiments of the disclosure, and a person of ordinary skill in the art may still derive other accompanying drawings from the accompanying drawings without creative efforts. In addition, one of ordinary skill would understand that aspects of example embodiments may be combined together or implemented alone.

FIG. 1 is a schematic flowchart of a data processing method according to some embodiments.

FIG. 2 is a schematic structural diagram of a data processing apparatus according to some embodiments.

FIG. 3 is a schematic structural diagram of a client according to some embodiments.

FIG. 4 is a schematic structural diagram of a server according to some embodiments.

### DESCRIPTION OF EMBODIMENTS

To make a person skilled in the art better understand solutions of this application, the technical solutions in the some embodiments are clearly and completely described below with reference to the accompanying drawings in the some embodiments. Apparently, the described embodiments are merely some rather than all of the some embodiments. Based on the some embodiments, all other embodiments obtained by a person of ordinary skill in the art without creative efforts shall fall within the protection scope of this application.

Exemplary embodiments are described in detail herein, and examples thereof are shown in the accompanying drawings. When the following descriptions are made with reference to the accompanying drawings, unless otherwise indicated, the same numbers in different accompanying drawings represent the same or similar elements. The following implementations described in the following exemplary embodiments do not represent all implementations that are consistent with the disclosure. Instead, they are merely examples of apparatuses and methods consistent with some aspects of the disclosure as recited in the appended claims.

According to a first aspect, some embodiments provide a data processing method, including:

determining a search keyword according to a search statement input by a user;

determining a first graph entity library corresponding to a category to which the search keyword belongs;

determining, according to an association relationship between graph entity libraries of each category, a category of a graph entity library associated with the first graph entity library, constructing a first set, the first set including at least one graph entity library which has an association relationship with the first graph entity library, pre-constructing the graph entity libraries of a plurality of categories, and establishing the association relationship between the graph entity libraries of the each category according to a search demand of the user; and

displaying each graph entity library included in the first set by using the search keyword as a center.

In some embodiments, the first set includes a second graph entity library, and the method further includes:

displaying a search content related to the second graph entity library and the search keyword, in response to a selection operation triggered by the user for the second graph entity library.

In some embodiments, after the in response to a selection operation triggered by the user for the second graph entity library, the method further includes:

determining, according to the association relationship between the graph entity libraries of the each category, a category of a graph entity library associated with the second graph entity library, and constructing a second set, the second set including at least one graph entity library which has an association relationship with the second graph entity library; and

displaying the each graph entity library included in the second set by using the second graph entity library as a center.

In some embodiments, the second set includes a third graph entity library, and the method further includes:

displaying a search content related to the search keyword, the second graph entity library, and the third graph entity library, in response to a selection operation triggered by the user for the third graph entity library.

In some embodiments, the search statement includes a first keyword, and the determining a search keyword according to a search statement input by a user includes:

querying the graph entity library, the graph entity library being each of the pre-constructed graph entity libraries of the plurality of categories; and

determining, in a case that a graph entity that hits the first keyword exists in the graph entity library, a normalized entity name corresponding to the graph entity that hits the first keyword as the search keyword.

In some embodiments, the establishing the association relationship between the graph entity libraries of the each category according to a search demand of the user includes:

obtaining a historical search statement, and determining a search keyword of the historical search statement and a search demand of the historical search statement;

determining a first category to which the search keyword of the historical search statement belongs and a second category corresponding to the search demand; and

establishing the association relationship between the graph entity library of the first category and the graph entity library of the second category.

In some embodiments, the establishing the association relationship between the graph entity libraries of the each category according to a search demand of the user includes:

obtaining a historical search statement, and determining a first category to which a search keyword of the historical search statement belongs;

obtaining a second category of the content viewed by a network user for the historical search statement; and

establishing the association relationship between the graph entity library of the first category and the graph entity library of the second category.

According to a second aspect, some embodiments provide a data processing apparatus, including:

a first determining unit, configured to determine a search keyword according to a search statement input by a user;

a second determining unit, configured to determine a first graph entity library corresponding to a category to which the search keyword belongs;

a first construction unit, configured to determine, according to an association relationship between graph entity libraries of each category, a category of a graph entity library associated with the first graph entity library, construct a first set, the first set including at least one graph entity library which has an association relationship with the first graph entity library, pre-construct the graph entity libraries of a plurality of categories, and establish the association relationship between the graph entity libraries of the each category according to a search demand of the user; and

a first display unit, configured to display each graph entity library included in the first set by using the search keyword as a center.

In some embodiments, the first set includes a second graph entity library, and the apparatus further includes:

a second display unit, configured to display a search content related to the second graph entity library and the search keyword, in response to a selection operation triggered by the user for the second graph entity library.

In some embodiments, the apparatus further includes:

a second construction unit, configured to determine, according to the association relationship between the graph entity libraries of the each category, a category of a graph entity library associated with the second graph entity library, and construct a second set, after the in response to a selection operation triggered by the user for the second graph entity library, the second set including at least one graph entity library which has an association relationship with the second graph entity library; and

a third display unit, configured to display the each graph entity library included in the second set by using the second graph entity library as a center.

In some embodiments, the second set includes a third graph entity library, and the apparatus further includes:

a fourth display unit, configured to display a search content related to the search keyword, the second graph entity library, and the third graph entity library, in response to a selection operation triggered by the user for the third graph entity library.

In some embodiments, the search statement includes a first keyword, and the first determining unit is configured to:

query the graph entity library, the graph entity library being each of the pre-constructed graph entity libraries of the plurality of categories; and

determine, in a case that a graph entity that hits the first keyword exists in the graph entity library, a normalized entity name corresponding to the graph entity that hits the first keyword as the search keyword.

In some embodiments, the establishing the association relationship between the graph entity libraries of the each category according to a search demand of the user includes:

obtaining a historical search statement, and determining a search keyword of the historical search statement and a search demand of the historical search statement;

determining a first category to which the search keyword of the historical search statement belongs and a second category corresponding to the search demand; and

establishing the association relationship between the graph entity library of the first category and the graph entity library of the second category.

In some embodiments, the establishing the association relationship between the graph entity libraries of the each category according to a search demand of the user includes:

obtaining a historical search statement, and determining a first category to which a search keyword of the historical search statement belongs;

obtaining a second category of the content viewed by a network user for the historical search statement; and

establishing the association relationship between the graph entity library of the first category and the graph entity library of the second category.

According to a third aspect, some embodiments provide a data processing apparatus, including a memory and one or more programs, the one or more programs being stored in the memory, and being configured to be executed by the one or more processors, and the one or more programs including instructions for performing the following operations:

determining a search keyword according to a search statement input by a user;

determining a first graph entity library corresponding to a category to which the search keyword belongs;

determining, according to an association relationship between graph entity libraries of each category, a category of a graph entity library associated with the first graph entity library, constructing a first set, the first set including at least one graph entity library which has an association relationship with the first graph entity library, pre-constructing the graph entity libraries of a plurality of categories, and establishing the association relationship between the graph entity libraries of the each category according to a search demand of the user; and

displaying each graph entity library included in the first set by using the search keyword as a center.

In some embodiments, the first set includes a second graph entity library, and the operations further include:

displaying a search content related to the second graph entity library and the search keyword, in response to a selection operation triggered by the user for the second graph entity library.

In some embodiments, after the in response to a selection operation triggered by the user for the second graph entity library, the operations further include:

determining, according to the association relationship between the graph entity libraries of the each category, a category of a graph entity library associated with the second graph entity library, and constructing a second set, the second set including at least one graph entity library which has an association relationship with the second graph entity library; and

displaying the each graph entity library included in the second set by using the second graph entity library as a center.

In some embodiments, the second set includes a third graph entity library, and the operations further include:

displaying a search content related to the search keyword, the second graph entity library, and the third graph entity library, in response to a selection operation triggered by the user for the third graph entity library.

In some embodiments, the search statement includes a first keyword, and the determining a search keyword according to a search statement input by a user includes:

querying the graph entity library, the graph entity library being each of the pre-constructed graph entity libraries of the plurality of categories; and

determining, in a case that a graph entity that hits the first keyword exists in the graph entity library, a normalized entity name corresponding to the graph entity that hits the first keyword as the search keyword.

In some embodiments, the establishing the association relationship between the graph entity libraries of the each category according to a search demand of the user includes:

obtaining a historical search statement, and determining a search keyword of the historical search statement and a search demand of the historical search statement;

determining a first category to which the search keyword of the historical search statement belongs and a second category corresponding to the search demand; and

establishing the association relationship between the graph entity library of the first category and the graph entity library of the second category.

In some embodiments, the establishing the association relationship between the graph entity libraries of the each category according to a search demand of the user includes:

obtaining a historical search statement, and determining a first category to which a search keyword of the historical search statement belongs;

obtaining a second category of the content viewed by a network user for the historical search statement; and

establishing the association relationship between the graph entity library of the first category and the graph entity library of the second category.

According to a fourth aspect, some embodiments provide a computer-readable storage medium, storing instructions, the instructions, when executed by one or more processors, causing an apparatus to perform the method according to any one of the foregoing first aspect.

Compared with the related technology, some embodiments have the following advantages.

Some embodiments provide a data processing method, including the following operations: A search keyword is determined according to a search statement input by a user. After the search keyword is determined, a first graph entity library corresponding to a category to which the search keyword belongs may be determined, where a graph entity in the first graph entity library belongs to the same category as the search keyword. After the first graph entity library is determined, a category of a graph entity library associated with the first graph entity library may be determined according to an association relationship between graph entity libraries of a plurality of categories, and a first set may be constructed. The first set includes at least one graph entity library which has an association relationship with the first graph entity library, and the association relationship between the graph entity libraries is established according to a search demand of the user. Since the association relationship between the graph entity libraries is established according to the search demand of the user, the first set may reflect the search demand of the search statement. After the first set is constructed, each graph entity library included in the first set may be displayed by using the search keyword as a center. Since the first set may reflect the search demand of the search statement, the first set may guide the user to further trigger a search behavior based on the search demand. Therefore, this solution may help to provide the user with a search result that meets demand of the user.

The inventors of this application have found through research that at present, when a user inputs a search statement in an input region of a search engine, the search engine uses the search statement or a keyword in the search statement as a search condition to obtain a search result. However, since there are many contents matching the search statement or the keyword in a network database, the search result determined by the search engine is not necessarily a search result that meets demand of the user.

To resolve the foregoing problem, some embodiments provide a data processing method and apparatus, which may provide the user with the search result that meets demand of the user.

Non-restrictive implementations of this application are described below in detail with reference to the accompanying drawings.

Exemplary Method

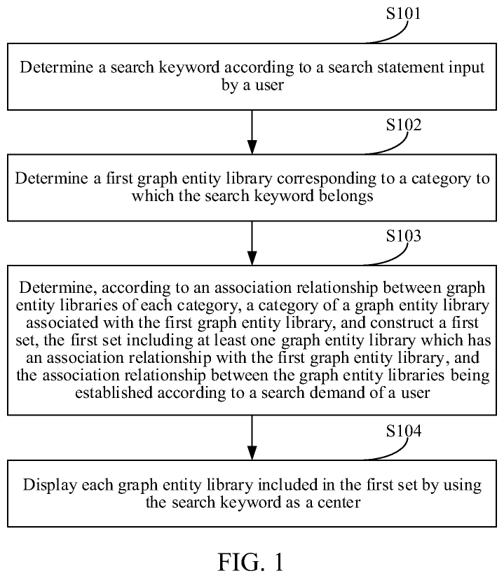

FIG. 1 is a schematic flowchart of a data processing method according to some embodiments. The method shown in FIG. 1 may be executed by, for example, a device running a search engine. The device mentioned herein includes, but is not limited to, a terminal device and a server. The terminal device mentioned herein may be a mobile terminal such as a mobile phone or a tablet computer, or may be a terminal device such as a desktop computer.

In this embodiment, the method may include the following S101 to S103.

S101: Determine a search keyword according to a search statement input by a user.

In some embodiments, after the user inputs the search statement in the input region provided by the search engine, the device running the search engine may analyze the search statement to obtain the search keyword.

In an example, the search keyword may be a participle of the search statement; and in another example, when the search statement includes only one participle, the search keyword may be the search statement.

In some scenarios, it is considered that the same object may have different names. For example, “urticaria” may also be referred to as “wheal” or “rubella”, where “urticaria” is the scientific name of the object. For an object with a plurality of names, the content input by the user in the input region of the search engine may be any one of the plurality of names. In consideration of this situation, in some embodiments, a graph entity library in the medical field may be pre-constructed, and the graph entity library may include a correspondence between the scientific name of each medical entity object and other names used to describe the medical entity object. For example, for “urticaria”, the graph entity library may include graph entity “urticaria”, graph entity “wheal”, and graph entity “rubella”. Further, the graph entity library may also include a correspondence between the three graph entities above. The scientific name “urticaria” may be used as a corresponding normalized entity name of the three graph entities, and the correspondence between each graph entity and the corresponding normalized entity name thereof may be established and stored in the medical graph entity library. Certainly, for an object with a unique entity name, the corresponding normalized entity name thereof is the graph entity.

In this case, in some embodiments, the search keyword may also be determined by using the graph entity library. The search statement may be first analyzed to obtain a first keyword. The first keyword may be a participle of the search statement, and when the search statement includes only one participle, the first keyword may be the search statement. After the first keyword is determined, the search keyword may be determined according to the first keyword and the graph entity library.

The determining a search keyword according to a search statement input by a user may include: querying the graph entity library, and using, in a case that a graph entity that hits the first keyword included in the search statement exists in the graph entity library, a normalized entity name corresponding to the graph entity that hits the first keyword as the search keyword. The first keyword may be obtained by analyzing the search statement input by the user.

It may be understood that the first keyword and the search keyword are both graph entities included in the graph entity library. For example, the first keyword is “wheal”, the graph entity “wheal” in the graph entity library hits the first keyword, and the graph entity library may include a correspondence between the graph entity “wheal” and the normalized entity name “urticaria”. Therefore, according to the first keyword and the graph entity library, the search keyword may be determined to be the normalized entity name “urticaria” corresponding to the graph entity “wheal”.

In addition to the foregoing graph entities of disease category, such as “urticaria” and “rubella”, the graph entities included in the graph entity library may further include graph entities of other categories, such as graph entities in various aspects such as mother and infant, examination, disease, hospital, medicine, symptom, and surgery, which are not listed herein. In addition, in addition to the graph entity, the graph entity library may further include the content corresponding to the graph entity. The content corresponding to the graph entity includes, but is not limited to, the introduction of the graph entity, the web page related to the graph entity, and the like.

S102: Determine a first graph entity library corresponding to a category to which the search keyword belongs.

In some embodiments, the pre-constructing the graph entity library in the medical field may include: pre-constructing graph entity libraries corresponding to a plurality of categories in the medical field respectively. In an example, a graph entity library of the disease category is constructed. The graph entity library of the disease category may include a plurality of graph entities, and one graph entity may correspond to a disease, such as hypertension or diabetes. In another example, a graph entity library of the symptom category is constructed. The graph entity library of the symptom category may include a plurality of graph entities, and one graph entity may correspond to one symptom, such as headache, abdominal pain, or vomiting. In still another example, a graph entity library of the medicine category is constructed. The graph entity library of the medicine category may include a plurality of graph entities, and one graph entity may correspond to one medicine, such as aspirin or cephalosporin. The categories of the graph entity library may also include, but are not limited to: disease, symptom, medicine, examination, surgery, medical aesthetics, hospital, first aid, food material, traditional Chinese medicine, mother and infant, and the like.

After the search keyword is determined, the first graph entity library corresponding to the category to which the search keyword belongs may be determined. If the category to which the search keyword belongs is determined, the pre-constructed graph entity library corresponding to the category is the first graph entity library. Then, a query may be performed in the first graph entity library to determine whether there is a graph entity that hits the search keyword.

For example, if the search keyword is “urticaria” and the category thereof is disease, the pre-constructed graph entity library of the disease category is the first graph entity library.

S103: Determine, according to an association relationship between graph entity libraries of each category, a category of a graph entity library associated with the first graph entity library, and construct a first set. The first set includes at least one graph entity library which has an association relationship with the first graph entity library, and the association relationship between the graph entity libraries is established according to a search demand of a user.

In some embodiments, the search demand of the user may be determined based on a historical search behavior of the user. In an example, when searching for the keyword of the disease category, the user may click and focus on the search result related to the symptom, the treatment method, the cause of the disease, and the like, and accordingly, it may be considered that when the user searches for the keyword of the disease category, the purpose is often to obtain the symptom, the treatment, the prevention, the cause of the disease, and the like. In another example, the historical search statement input by the user reflects the search demand of the user. For example, if the historical search statement is “what are the symptoms of hypertension?”, the search demand reflected by the historical search statement is to obtain symptoms related to hypertension. Based on this, based on a large number of historical search behaviors of the user, the association relationship between the graph entity library of the disease category and the graph entity libraries of categories such as symptom category and treatment category may be established relatively.

In some embodiments, in order to provide the user with the search result that meets the demand of the user, the association relationship between the graph entity libraries of the plurality of categories may be pre-constructed. The association relationship between the graph entity libraries of the plurality of categories may be used to indicate the search demand of the user. In an example, the association relationship between the graph entity libraries of the plurality of categories includes an association relationship between the graph entity library of a first category and the graph entity library of a second category. Accordingly, if the search keyword input by the user hits the graph entity included in the graph entity library of the first category, it may be considered that the graph entity included in the graph entity library of the second category may also meet the search demand of the user. Therefore, the graph entity library of the second category may be added to the first set corresponding to the graph entity library of the first category according to the association relationship between the graph entity library of the first category and the graph entity library of the second category.

For example, the search keyword of the user is “urticaria”, the first graph entity library is the disease graph entity library, and the categories of the graph entity libraries associated with the disease graph entity library may include: symptom, treatment, etiology, medicine, and the like. Therefore, the first set may be constructed, and the first set may include {the graph entity library of the symptom category, the graph entity library of the treatment category, the graph entity library of the cause category, and the graph entity library of the medicine category}. Each graph entity library included in the first set represents a possible search demand of the user.

The following describes the construction manner of the association relationship between the graph entity libraries of the plurality of categories.

In an example, the association relationship between the graph entity libraries of the plurality of categories may be established according to the historical search behavior of the network user. Establishing the association relationship between the graph entity libraries of the plurality of categories based on the historical search behavior of the network user may have a plurality of implementations when implemented. Two possible implementations are described below.

First implementation: As mentioned above, the historical search statement may be capable of reflecting the search demand of the user. Therefore, the historical search statement may be analyzed to obtain the search keyword and the search demand of the user. And, the category corresponding to the search keyword and the category corresponding to the search demand may be determined, and then an association relationship between the graph entity library of the category corresponding to the search keyword and the graph entity library of the category corresponding to the search demand may be established.

For example, if the historical search statement is “what are symptoms of hypertension”, the search keyword of the historical search statement is “hypertension”. By identifying the demand for the search statement, the corresponding search demand thereof may be determined to be symptom. “Hypertension” belongs to the disease category, and the search demand belongs to the symptom category. Therefore, an association relationship between the graph entity library of the disease category and the graph entity library of the symptom category may be established.

In another example, the historical search statement is “how to control hypertension”, the search keyword of the historical search statement is “hypertension”, and the search demand is “control”. “Hypertension” belongs to the disease category, and “control” belongs to the treatment category. Therefore, an association relationship between the graph entity library of the disease category and the graph entity library of the treatment category may be established.

Second implementation: The association relationship between a plurality of graph entity libraries may be established based on the historical search statement and search results clicked or viewed by the user. For example, the historical search statement is “hypertension”, and when inputting the historical search statement, the network user clicks and focuses on search results related to the symptom, the treatment method, the cause of the disease, and the like. Therefore, the association relationship between the graph entity library of the disease category and the graph entity library of the symptom category, and the association relationship between the graph entity library of the disease category and the graph entity library of the treatment category or other category may be established.

In another example, the correspondence between the graph entity libraries of the plurality of categories is established by manual annotation. For example, the correspondence between the graph entity library of the disease category and the graph entity library of the treatment category, and the correspondence between the graph entity library of the disease category and the graph entity library of the symptom category may be established by manual annotation.

Since the correspondence between the graph entity libraries of the plurality of categories is pre-constructed, after the first graph entity library corresponding to the category to which the search keyword belongs is determined, the first set may be constructed based on the pre-constructed correspondence between the graph entity libraries of the plurality of categories. The first set includes at least one graph entity library which has an association relationship with the first graph entity library, and each graph entity library in the first set may correspond to a category respectively. As may be learned from the above description of the association relationship between the graph entity libraries of the plurality of categories, the first set may reflect the search demand of the search keyword.

For example, the first graph entity library is the graph entity library of the disease category, and the association relationship between the graph entity libraries of the plurality of categories includes the association relationship between the graph entity library of the disease category and the graph entity library of the symptom category, and the association relationship between the graph entity library of the disease category and the graph entity library of the treatment category. Therefore, according to the association relationship between the graph entity libraries of the plurality of categories, it is determined that the first set includes the graph entity library of the symptom category and the graph entity library of the treatment category.

Certainly, for the graph entity library of the disease category, the first set may include, but is not limited to, the foregoing graph entity library of the symptom category and the graph entity library of the treatment category, and may further include the graph entity library of the cause category, the graph entity library of the diet conditioning category, the graph entity library of the disease prevention category, and the like.

S104: Display each graph entity library included in the first set by using the search keyword as a center.

After the first set is determined, the first set may be displayed on a search result page. The each graph entity library included in the first set is displayed, and the association between each graph entity library and the search keyword is displayed. The category name corresponding to the each graph entity library may be displayed on the search result page. For example, the search keyword is “hypertension”, and the corresponding first graph entity library thereof is the graph entity library of the disease category. The first set may include {the graph entity library of the symptom category, the graph entity library of the treatment category, the graph entity library of the cause category, the graph entity library of the medicine category . . . }. In some embodiments, when the first set is displayed, in order to achieve an intuitive display effect, “symptom”, “treatment”, “cause”, and the like may be displayed on the search result page by using “hypertension” as a center, and the associations of “hypertension” with “symptom”, “treatment”, “cause”, and the like may be established respectively, for example, connecting in a line form.

Since the graph entity library in the first set may reflect a possible search intention of the user corresponding to the search keyword, after the each graph entity library included in the first set is displayed on the search result page, the user may trigger a search behavior based on the graph entity library in the first set to obtain the content that the user intends to obtain. In other words, the first set may guide the user to trigger a search based on the content intended to be obtained. Therefore, by using this solution, the user may be provided with the search result that meets the demand of the user. When the user triggers a search behavior for a certain graph entity library in the first set, the search is triggered by using the search keyword and the category to which the graph entity library belongs as a common search condition, and a corresponding search result is returned. For example, if the search keyword is “hypertension”, and the user triggers the “symptom” in the first set, the search is triggered by using “hypertension symptom” as a search condition, and a search result related to “hypertension symptom”, especially a question and answer search result is returned to the user, to meet the search demand of the user based on the search keyword “hypertension” and “symptom”.

In some embodiments, considering that for a second graph entity library in the first set, the search intention of the user inputting the search statement is often to obtain content related to the second graph entity library and the search keyword. For example, if the search keyword is “hypertension”, and the second graph entity library is the graph entity library of the symptom category, the user often searches for hypertension to know the symptom of hypertension. In view of this, in some embodiments, content related to the second graph entity library and the search keyword may also be displayed.

In some embodiments, the content related to the second graph entity library and the search keyword is displayed. In a specific implementation, for example, the search may be triggered by using the search keyword and the category to which the second graph entity library belongs as a common search condition, to search for a corresponding search result from the network or the second graph entity library. After the search result is found, the search result may be displayed.

Further, the association relationship between the search result and the second graph entity library may be established, and the search result may be displayed in association when the each graph entity library included in the first set is displayed by using the search keyword as a center. When the user triggers the second graph entity library or a mouse hovers over the second graph entity library, the search result is displayed, the search result being obtained by searching using the search keyword and the category to which the second graph entity library belongs as the common search condition.

Considering that in addition to the second graph entity library, the first set further includes other graph entity libraries, if the content related to the search keyword and the graph entity library is displayed for each graph entity library in the first set, the displayed content is too much, which is not conducive to targeted selection and browsing for the user. As mentioned above, the first graph entity library set may guide the user to trigger a search based on the content intended to be obtained. Therefore, in an example, after the user triggers a selection operation for the second graph entity library, a device running a search engine may perform an operation of displaying the content related to the second graph entity library and the search keyword, in response to the selection operation triggered by the user for the second graph entity library.

In some embodiments, the selection operation triggered by the user for the second graph entity library, for example, may be that the user clicks a display region in which the second graph entity library is located.

In some embodiments, the display region may be divided into a plurality of regions, one of the regions is used to display the first set and the search keyword, and the other region is used to display the content related to the second graph entity library and the search keyword. For example, the display region is divided into two regions: an upper region and a lower region. The upper region is used to display the first set and the search keyword, and the lower region is used to display the content related to the second graph entity library and the search keyword.

In some embodiments, the content related to the second graph entity library and the search keyword may include an introduction related to the second graph entity library and the search keyword, a web page related to the second graph entity library and the search keyword, and the like.

In an implementation, considering that the purpose of the selection operation triggered by the user for the second graph entity library is to obtain more details related to the second graph entity library, for the foregoing second graph entity library for which the user triggers the selection operation, the second set may be further constructed according to the association relationship between the graph entities of the plurality of categories, the second set including at least one graph entity library which has an association relationship with the second graph entity library. It may be understood that the graph entity library in the second set may reflect the search intention of the user which is in favor of the second graph entity library based on the search keyword and the first graph entity library. After the second set is determined, the second set may be displayed.

In an example, the each graph entity library included in the second set may be displayed by using the second graph entity library as a center. For example, if the search keyword is “hypertension” and the user triggers the “symptom” in the first set, the second set corresponding to the “symptom” is constructed, such as {the graph entity library of the treatment category, the graph entity library of the prevention category, the graph entity library of the diet category . . . }. “Treatment”, “prevention”, “diet”, and the like may be displayed on the search result page by using the “symptom” as a center. In addition, the associations of “symptom” with “treatment”, “prevention” and “diet” are established respectively, for example, connecting in a line form.

In some embodiments, when the second set is displayed, in order to achieve an intuitive display effect, the each graph entity in the second set may be displayed around the second graph entity library in a decentralized form. By using this implementation, the user may intuitively determine the plurality of graph entity libraries associated with the second graph entity library according to the displayed content. It may be understood that, similar to the first set, the second set may also guide the user to trigger a search based on the content intended to be obtained.

When the user triggers a search behavior for a third graph entity library in the second set, the content related to the search keyword, the second graph entity library, and the third graph entity library may also be displayed. The search may be triggered by using the search keyword, the category to which the second graph entity library belongs, and the category to which the third graph entity library belongs as the common search condition, and a corresponding search result is returned. For example, when the search keyword is “hypertension”, the user triggers the “symptom” in the first set, and the second set corresponding to the “symptom” is displayed. And, the user further triggers the “diet” in the second set, the search is triggered by using “hypertension, symptom, diet” as the search condition, and a search result related to “hypertension, symptom, diet”, especially a question and answer search result is returned to the user, to meet the search demand of the user. When the search is triggered by using the search keyword, the category to which the second graph entity library belongs, and the category to which the third graph entity library belongs as the common search condition, the corresponding search result may be found in the network, the second graph entity library, and the third graph entity library. This embodiment is not specifically limited.

Considering that in addition to the third graph entity library, the second set further includes other graph entity libraries, if the related search content is displayed for any graph entity library in the second set display, the displayed content is too much, which is not conducive to targeted selection and browsing for the user. As mentioned above, the second set may guide the user to trigger a search based on the content intended to be obtained. Therefore, in an example, after the user triggers a selection operation for the third graph entity library, a device running a search engine may perform an operation of displaying the search content related to the search keyword, the second graph entity library, and the third graph entity library, in response to the selection operation triggered by the user for the third graph entity library.

In some embodiments, the selection operation triggered by the user for the third graph entity library, for example, may be that the user clicks a display region in which the third graph entity library is located.

In some embodiments, the display region may be divided into a plurality of regions, one of the regions is used to display the second set and the category to which the second graph entity library belongs, and the other region is used to display the content related to the search keyword, the second graph entity library, and the third graph entity library. For example, the display region is divided into two regions: an upper region and a lower region. The upper region is used to display the second set and the category to which the second graph entity library belongs, and the lower region is used to display the content related to the search keyword, the second graph entity library, and the third graph entity library.

In some embodiments, the graph entity library displayed to the user may be expanded layer by layer according to the selection operation triggered by the user for one of the graph entity libraries, so as to provide the user with refined search services.

In an example, after the user triggers the selection operation for the third graph entity library, a third set may be further constructed according to the association relationship between the graph entity libraries of the each category, the third set including at least one graph entity library which has an association relationship with the third graph entity library. It may be understood that the graph entity library in the third set may reflect the search intention of the user which is in favor of the third graph entity library based on the search keyword, the first graph entity library, and the second graph entity library. After the third set is determined, the each graph entity library included in the third set may be displayed by using the third graph entity library as a center, thereby guiding the user to trigger a search behavior based on the third set.

Further, after the user triggers a selection operation for a fourth graph entity library in the third set, a fourth set may be further constructed according to the association relationship between the graph entity libraries of the each category, the fourth set including at least one graph entity library which has an association relationship with the fourth graph entity library. It may be understood that the graph entity library in the fourth set may reflect the search intention of the user which is in favor of the fourth graph entity library based on the search keyword, the first graph entity library, the second graph entity library, and the third graph entity library. After the fourth set is determined, the each graph entity library included in the fourth set may be displayed by using the fourth graph entity library as a center, thereby guiding the user to trigger a search behavior based on the fourth set.

The rest may be deduced by analogy, and examples are not listed one by one herein.

In addition, after the user triggers the selection operation for the fourth graph entity library in the third set, the content related to the second graph entity library, the third graph entity library, the fourth graph entity library, and the search keyword may also be displayed. In a specific implementation, for example, the search may be triggered by using the search keyword, the category to which the second graph entity library belongs, the category to which the third graph entity library belongs, and the category to which the fourth graph entity library belongs as a common search condition, to obtain a corresponding search result. After the search result is obtained, the search result may be displayed.

Exemplary Apparatus

Based on the method provided in the foregoing embodiments, the some embodiments further provide an apparatus, which is described below with reference to the accompanying drawings.

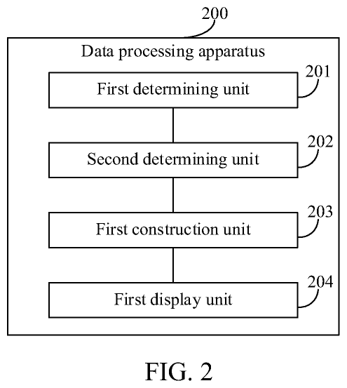

Referring to FIG. 2, FIG. 2 is a schematic structural diagram of a data processing apparatus according to some embodiments. The apparatus 200, for example, may include: a first determining unit 201, a second determining unit 202, a first construction unit 203, and a first display unit 204.

The first determining unit 201 is configured to determine a search keyword according to a search statement input by a user;

the second determining unit 202 is configured to determine a first graph entity library corresponding to a category to which the search keyword belongs;

the first construction unit 203 is configured to determine, according to an association relationship between graph entity libraries of each category, a category of a graph entity library associated with the first graph entity library, construct a first set, the first set including at least one graph entity library which has an association relationship with the first graph entity library, pre-construct the graph entity libraries of a plurality of categories, and establish the association relationship between the graph entity libraries of the each category according to a search demand of the user; and

the first display unit 204 is configured to display each graph entity library included in the first set by using the search keyword as a center.

In some embodiments, the first set includes a second graph entity library, and the apparatus further includes:

a second display unit, configured to display a search content related to the second graph entity library and the search keyword, in response to a selection operation triggered by the user for the second graph entity library.

In some embodiments, the apparatus further includes:

a second construction unit, configured to determine, according to the association relationship between the graph entity libraries of the each category, a category of a graph entity library associated with the second graph entity library, and construct a second set, after the in response to a selection operation triggered by the user for the second graph entity library, the second set including at least one graph entity library which has an association relationship with the second graph entity library; and

a third display unit, configured to display the each graph entity library included in the second set by using the second graph entity library as a center.

In some embodiments, the second set includes a third graph entity library, and the apparatus further includes:

a fourth display unit, configured to display a search content related to the search keyword, the second graph entity library, and the third graph entity library, in response to a selection operation triggered by the user for the third graph entity library.

In some embodiments, the search statement includes a first keyword, and the first determining unit 201 is configured to:

query the graph entity library, the graph entity library being each of the pre-constructed graph entity libraries of the plurality of categories; and

determine, in a case that a graph entity that hits the first keyword exists in the graph entity library, a normalized entity name corresponding to the graph entity that hits the first keyword as the search keyword.

In some embodiments, the establishing the association relationship between the graph entity libraries of the each category according to a search demand of the user includes:

obtaining a historical search statement, and determining a search keyword of the historical search statement and a search demand of the historical search statement;

determining a first category to which the search keyword of the historical search statement belongs and a second category corresponding to the search demand; and

establishing the association relationship between the graph entity library of the first category and the graph entity library of the second category.

In some embodiments, the establishing the association relationship between the graph entity libraries of the each category according to a search demand of the user includes:

obtaining a historical search statement, and determining a first category to which a search keyword of the historical search statement belongs;

obtaining a second category of the content viewed by a network user for the historical search statement; and

establishing the association relationship between the graph entity library of the first category and the graph entity library of the second category.

Since the apparatus 200 is an apparatus corresponding to the method provided by the above method embodiment, the specific implementation of each unit of the apparatus 200 has the same concept as the above method embodiment. Therefore, the specific implementation of each unit of the apparatus 200 may refer to the description of the above method embodiment, and will not be repeated herein.

The method provided by the some embodiments may be executed by a client or a server. The client and server performing the above method are described respectively below.

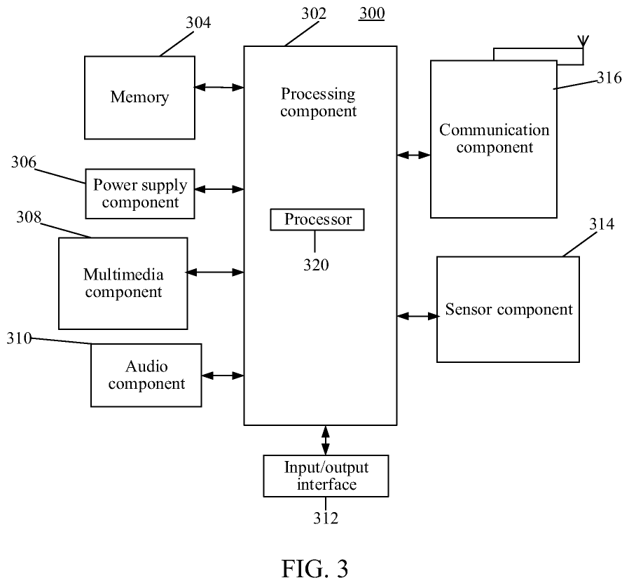

FIG. 3 shows a block diagram of a client 300. For example, the client 300 may be a mobile phone, a computer, a digital broadcasting terminal, a messaging device, a game console, a tablet device, a medical device, a fitness facility, a personal digital assistant, or the like.

Referring to FIG. 3, the client 300 may include one or more components as follows: a processing component 302, a memory 304, a power supply component 306, a multimedia component 308, an audio component 310, an input/output (I/O) interface 33, a sensor component 314, and a communication component 316.

The processing component 302 generally controls integral operations of the client 300, such as operations related to displaying, a phone call, data communication, a camera operation, and a record operation. The processing component 302 may include one or more processors 320 to execute instructions, to complete all or some operations of the foregoing method. In addition, the processing component 302 may include one or more modules, to facilitate the interaction between the processing component 302 and other components. For example, the processing component 302 may include a multimedia module, to facilitate the interaction between the multimedia component 308 and the processing component 302.

The memory 304 is configured to store data of various types to support operations on the client 300. Examples of the data include instructions of any application program or method that are used for operations on the client 300, such as contact data, address book data, a message, a picture, and a video. The memory 304 may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disc, or an optical disc.

The power supply component 306 provides power to various components of the client 300. The power supply component 306 may include a power supply management system, one or more power supplies, and other components associated with generating, managing and allocating power for the client 300.

The multimedia component 308 includes a screen providing an output interface between the client 300 and a user. In some embodiments, the screen may include a liquid crystal display (LCD) and a touch panel (TP). If the screen includes a TP, the screen may be implemented as a touchscreen, to receive an input signal from the user. The TP includes one or more touch sensors to sense touching, sliding, and gestures on the TP. The touch sensor may not only sense the boundary of touching or sliding operations, but also detect duration and pressure related to the touching or sliding operations. In some embodiments, the multimedia component 308 includes a front camera and/or a rear camera. When the client 300 is in an operating mode, such as a shooting mode or a video mode, the front camera and/or the rear camera may receive external multimedia data. Each front camera and rear camera may be a fixed optical lens system or have a focal length and an optical zooming capability.

The audio component 310 is configured to output and/or input an audio signal. For example, the audio component 310 includes a microphone (MIC). When the client 300 is in the operating mode, such as a call mode, a record mode, and a speech recognition mode, the microphone is configured to receive an external audio signal. The received audio signal may be further stored in the memory 304 or transmitted through the communication component 316. In some embodiments, the audio component 310 further includes a loudspeaker, configured to output an audio signal.

The I/O interface provides an interface between the processing component 302 and an external interface module. The external interface module may be a keyboard, a click wheel, buttons, or the like. These buttons may include, but are not limited to: a homepage button, a volume button, a start-up button, and a locking button.

The sensor component 314 includes one or more sensors, configured to provide state evaluation in each aspect to the client 300. For example, the sensor component 314 may detect a powered-on/off state of the client 300 and relative positioning of components. For example, the components are a display and a keypad of the client 300. The sensor component 314 may further detect changes in a location of the client 300 or a component of the client 300, a touch between the user and the client 300, an azimuth or acceleration/deceleration of the client 300 and changes in a temperature of the client 300. The sensor component 314 may include a proximity sensor, configured to detect the existence of nearby objects without any physical contact. The sensor component 314 may further include an optical sensor, such as a CMOS or CCD image sensor, that is used in an imaging application. In some embodiments, the sensor component 314 may further include an acceleration sensor, a gyroscope sensor, a magnetic sensor, a pressure sensor, or a temperature sensor.

The communication component 316 is configured to facilitate communication in a wired or wireless manner between the client 300 and other devices. The client 300 may access a communication standard-based wireless network, such as WiFi, 2G, or 3G, or a combination thereof. In an exemplary embodiment, the communication component 316 receives a broadcast signal or broadcast related information from an external broadcast management system through a broadcast channel. In an exemplary embodiment, the communication component 316 further includes a near field communication (NFC) module, to promote short range communication. For example, the NFC module may be implemented based on a radio frequency identification (RFID) technology, an infra-red data association (IrDA) technology, an ultra-wideband (UWB) technology, a Bluetooth (BT) technology, and other technologies.

In an exemplary embodiment, the client 300 may be implemented as one or more application specific integrated circuit (ASIC), a digital signal processor (DSP), a digital signal processing device (DSPD), a programmable logic device (PLD), a field programmable gate array (FPGA), a controller, a micro-controller, a microprocessor or other electronic element, so as to perform the following method:

determining a search keyword according to a search statement input by a user;

determining a first graph entity library corresponding to a category to which the search keyword belongs;

determining, according to an association relationship between graph entity libraries of each category, a category of a graph entity library associated with the first graph entity library, constructing a first set, the first set including at least one graph entity library which has an association relationship with the first graph entity library, pre-constructing the graph entity libraries of a plurality of categories, and establishing the association relationship between the graph entity libraries of the each category according to a search demand of the user; and

displaying each graph entity library included in the first set by using the search keyword as a center.

In some embodiments, the first set includes a second graph entity library, and the method further includes:

displaying a search content related to the second graph entity library and the search keyword, in response to a selection operation triggered by the user for the second graph entity library.

In some embodiments, after the in response to a selection operation triggered by the user for the second graph entity library, the method further includes:

determining, according to the association relationship between the graph entity libraries of the each category, a category of a graph entity library associated with the second graph entity library, and constructing a second set, the second set including at least one graph entity library which has an association relationship with the second graph entity library; and

displaying the each graph entity library included in the second set by using the second graph entity library as a center.

In some embodiments, the second set includes a third graph entity library, and the method further includes:

displaying a search content related to the search keyword, the second graph entity library, and the third graph entity library, in response to a selection operation triggered by the user for the third graph entity library.

In some embodiments, the search statement includes a first keyword, and the determining a search keyword according to a search statement input by a user includes:

querying the graph entity library, the graph entity library being each of the pre-constructed graph entity libraries of the plurality of categories; and

determining, in a case that a graph entity that hits the first keyword exists in the graph entity library, a normalized entity name corresponding to the graph entity that hits the first keyword as the search keyword.

In some embodiments, the establishing the association relationship between the graph entity libraries of the each category according to a search demand of the user includes:

obtaining a historical search statement, and determining a search keyword of the historical search statement and a search demand of the historical search statement;

determining a first category to which the search keyword of the historical search statement belongs and a second category corresponding to the search demand; and

establishing the association relationship between the graph entity library of the first category and the graph entity library of the second category.

In some embodiments, the establishing the association relationship between the graph entity libraries of the each category according to a search demand of the user includes:

obtaining a historical search statement, and determining a first category to which a search keyword of the historical search statement belongs;

obtaining a second category of the content viewed by a network user for the historical search statement; and

establishing the association relationship between the graph entity library of the first category and the graph entity library of the second category.

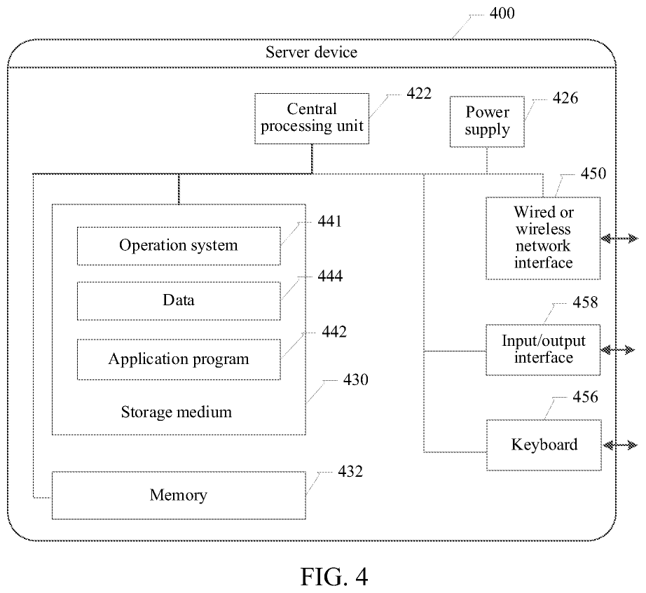

FIG. 4 is a schematic structural diagram of a server according to some embodiments. The server 400 may vary greatly due different configurations or performance, and may include one or more central processing units (CPU) 422 (for example, one or more processors) and memories 432, and one or more storage media 430 (for example, one or more mass storage devices) storing an application program 442 or data 444. The memory 432 and the storage medium 430 may be a transient memory or a persistent memory. A program stored in the storage medium 430 may include one or more modules (not shown), and each module may include a series of instruction operations for the server. Further, the CPU 422 may be configured to communicate with the storage medium 430 to execute a series of instruction operations in the storage medium 430 on the server 400.

Further, the CPU 422 may perform the following method:

determining a search keyword according to a search statement input by a user;

determining a first graph entity library corresponding to a category to which the search keyword belongs;

determining, according to an association relationship between graph entity libraries of each category, a category of a graph entity library associated with the first graph entity library, constructing a first set, the first set including at least one graph entity library which has an association relationship with the first graph entity library, pre-constructing the graph entity libraries of a plurality of categories, and establishing the association relationship between the graph entity libraries of the each category according to a search demand of the user; and

displaying each graph entity library included in the first set by using the search keyword as a center.

In some embodiments, the first set includes a second graph entity library, and the method further includes:

displaying a search content related to the second graph entity library and the search keyword, in response to a selection operation triggered by the user for the second graph entity library.

In some embodiments, after the in response to a selection operation triggered by the user for the second graph entity library, the method further includes:

determining, according to the association relationship between the graph entity libraries of the each category, a category of a graph entity library associated with the second graph entity library, and constructing a second set, the second set including at least one graph entity library which has an association relationship with the second graph entity library; and

displaying the each graph entity library included in the second set by using the second graph entity library as a center.

In some embodiments, the second set includes a third graph entity library, and the method further includes:

displaying a search content related to the search keyword, the second graph entity library, and the third graph entity library, in response to a selection operation triggered by the user for the third graph entity library.

In some embodiments, the search statement includes a first keyword, and the determining a search keyword according to a search statement input by a user includes:

querying the graph entity library, the graph entity library being each of the pre-constructed graph entity libraries of the plurality of categories; and

determining, in a case that a graph entity that hits the first keyword exists in the graph entity library, a normalized entity name corresponding to the graph entity that hits the first keyword as the search keyword.

In some embodiments, the establishing the association relationship between the graph entity libraries of the each category according to a search demand of the user includes:

obtaining a historical search statement, and determining a search keyword of the historical search statement and a search demand of the historical search statement;

determining a first category to which the search keyword of the historical search statement belongs and a second category corresponding to the search demand; and

establishing the association relationship between the graph entity library of the first category and the graph entity library of the second category.

In some embodiments, the establishing the association relationship between the graph entity libraries of the each category according to a search demand of the user includes:

obtaining a historical search statement, and determining a first category to which a search keyword of the historical search statement belongs;

obtaining a second category of the content viewed by a network user for the historical search statement; and

establishing the association relationship between the graph entity library of the first category and the graph entity library of the second category.

The server 400 may further include one or more power supplies 426, one or more wired or wireless network interfaces 450, one or more input/output interfaces 456, one or more keyboards 456, and/or, one or more operating systems 441, for example, Windows Server™, Mac OS X™, Unix™, Linux™, and FreeBSD™.

Some embodiments further provide a computer-readable storage medium, storing instructions, the instructions, when executed by one or more processors, causing an apparatus to perform the data processing method provided in the method embodiment above.

Other embodiments will be apparent to a person skilled in the art from consideration of the specification and practice of the disclosed invention here. This application is intended to cover any variations, uses, or adaptive changes of this application. These variations, uses, or adaptive changes follow the general principles of this application and include common general knowledge or common technical means in the art, which are not disclosed in this application. The specification and the embodiments are considered as merely exemplary, and the scope and spirit of this application are pointed out in the following claims.

It is to be understood that this application is not limited to the precise structures described above and shown in the accompanying drawings, and various modifications and changes may be made without departing from the scope of this application. The scope of this application is limited by the appended claims only.

The foregoing descriptions are merely exemplary embodiments and are not intended to limit this application. Any modification, equivalent replacement, or improvement made without departing from the spirit and principle of this application shall fall within the protection scope of this application.

What is claimed is:

1. A data processing method, performed by at least one processor and comprising:
determining a search keyword according to a search statement input by a user;
determining a first graph entity library corresponding to a category to which the search keyword belongs;
determining, according to an association relationship between graph entity libraries of each category, a category of a graph entity library associated with the first graph entity library,
constructing a first set, the first set comprising at least one graph entity library which has an association relationship with the first graph entity library,
pre-constructing the graph entity libraries of a plurality of categories,
establishing the association relationship between the graph entity libraries of the each category according to a search demand of the user; and
displaying each graph entity library comprised in the first set by using the search keyword as a center.

2. The method according to claim 1, wherein the first set comprises a second graph entity library, and the method further comprises:
displaying a search content related to the second graph entity library and the search keyword, in response to a selection operation triggered by the user for the second graph entity library.

3. The method according to claim 2, further comprising:
determining, according to the association relationship between the graph entity libraries of the each category, a category of a graph entity library associated with the second graph entity library, and constructing a second set, the second set comprising at least one graph entity library which has an association relationship with the second graph entity library; and
displaying the each graph entity library comprised in the second set by using the second graph entity library as a center.

4. The method according to claim 3, wherein the second set comprises a third graph entity library, and the method further comprises:
displaying a search content related to the search keyword, the second graph entity library, and the third graph entity library, in response to a selection operation triggered by the user for the third graph entity library.

5. The method according to claim 1, wherein the search statement comprises a first keyword, and the determining a search keyword according to a search statement input by a user comprises:
querying the graph entity library, the graph entity library being each of the pre-constructed graph entity libraries of the plurality of categories; and
determining, in a case that a graph entity that hits the first keyword exists in the graph entity library, a normalized entity name corresponding to the graph entity that hits the first keyword as the search keyword.

6. The method according to claim 1, further comprising:
obtaining a historical search statement, and determining a search keyword of the historical search statement and a search demand of the historical search statement;
determining a first category to which the search keyword of the historical search statement belongs and a second category corresponding to the search demand; and
establishing the association relationship between the graph entity library of the first category and the graph entity library of the second category.

7. The method according to claim 1, further comprising:
obtaining a historical search statement, and determining a first category to which a search keyword of the historical search statement belongs;
obtaining a second category of the content viewed by a network user for the historical search statement; and
establishing the association relationship between the graph entity library of the first category and the graph entity library of the second category.

8. A data processing apparatus, comprising:
at least one memory configured to store program code; and
at least one processor configured to read the program code and operate as instructed by the program code, the program code comprising:
first determining code, configured to cause the at least one processor to determine a search keyword according to a search statement input by a user;
second determining code, configured to cause the at least one processor to determine a first graph entity library corresponding to a category to which the search keyword belongs;
first construction code, configured to cause the at least one processor to determine, according to an association relationship between graph entity libraries of each category, a category of a graph entity library associated with the first graph entity library, construct a first set, the first set comprising at least one graph entity library which has an association relationship with the first graph entity library, pre-construct the graph entity libraries of a plurality of categories, and establish the association relationship between the graph entity libraries of the each category according to a search demand of the user; and
first display code, configured to cause the at least one processor to display each graph entity library comprised in the first set by using the search keyword as a center.

9. The apparatus according to claim 8, wherein the first set comprises a second graph entity library, and the apparatus further comprises:
second display code, configured to cause the at least one processor to display a search content related to the second graph entity library and the search keyword, in response to a selection operation triggered by the user for the second graph entity library.

10. The apparatus according to claim 9, the apparatus further comprising:
second construction code, configured to cause the at least one processor to determine, according to the association relationship between the graph entity libraries of the each category, a category of a graph entity library associated with the second graph entity library, and construct a second set, after the in response to a selection operation triggered by the user for the second graph entity library, the second set comprising at least one graph entity library which has an association relationship with the second graph entity library; and
third display code, configured to cause the at least one processor to display the each graph entity library comprised in the second set by using the second graph entity library as a center.

11. The apparatus according to claim 10, wherein the second set comprises a third graph entity library, and the apparatus further comprises:
fourth display code, configured to cause the at least one processor to display a search content related to the search keyword, the second graph entity library, and the third graph entity library, in response to a selection operation triggered by the user for the third graph entity library.

12. The apparatus according to claim 8, wherein the search statement comprises a first keyword, and the first determining code is configured to cause the at least one processor to:
query the graph entity library, the graph entity library being each of the pre-constructed graph entity libraries of the plurality of categories; and
determine, in a case that a graph entity that hits the first keyword exists in the graph entity library, a normalized entity name corresponding to the graph entity that hits the first keyword as the search keyword.

13. The apparatus according to claim 8, wherein the first construction code is configured to cause the at least one processor to:
obtain a historical search statement, and determining a search keyword of the historical search statement and a search demand of the historical search statement;
determine a first category to which the search keyword of the historical search statement belongs and a second category corresponding to the search demand; and
establish the association relationship between the graph entity library of the first category and the graph entity library of the second category.

14. The apparatus according to claim 8, wherein the first construction code is configured to cause the at least one processor to:
obtain a historical search statement, and determine a first category to which a search keyword of the historical search statement belongs;
obtain a second category of the content viewed by a network user for the historical search statement; and
establish the association relationship between the graph entity library of the first category and the graph entity library of the second category.

15. A non-transitory computer-readable storage medium, storing a computer program that when executed by at least one processor causes the at least one processor to:
determine a search keyword according to a search statement input by a user;
determine a first graph entity library corresponding to a category to which the search keyword belongs;
determine, according to an association relationship between graph entity libraries of each category, a category of a graph entity library associated with the first graph entity library,
construct a first set, the first set comprising at least one graph entity library which has an association relationship with the first graph entity library,
pre-construct the graph entity libraries of a plurality of categories
establish the association relationship between the graph entity libraries of the each category according to a search demand of the user; and
display each graph entity library comprised in the first set by using the search keyword as a center.

16. The non-transitory computer-readable storage medium according to claim 15, wherein the first set comprises a second graph entity library, and the program further causes the at least one processor to:
display a search content related to the second graph entity library and the search keyword, in response to a selection operation triggered by the user for the second graph entity library.

17. The non-transitory computer-readable storage medium according to claim 16, wherein the program further causes the at least one processor to:
determine, according to the association relationship between the graph entity libraries of the each category, a category of a graph entity library associated with the second graph entity library,
construct a second set, the second set comprising at least one graph entity library which has an association relationship with the second graph entity library; and
display the each graph entity library comprised in the second set by using the second graph entity library as a center.

18. The non-transitory computer-readable storage medium according to claim 17, wherein the second set comprises a third graph entity library, and the program further causes the at least one processor to:
display a search content related to the search keyword, the second graph entity library, and the third graph entity library, in response to a selection operation triggered by the user for the third graph entity library.

19. The non-transitory computer-readable storage medium according to claim 15, wherein the search statement comprises a first keyword, and the program further causes the at least one processor to:
query the graph entity library, the graph entity library being each of the pre-constructed graph entity libraries of the plurality of categories; and
determine, in a case that a graph entity that hits the first keyword exists in the graph entity library, a normalized entity name corresponding to the graph entity that hits the first keyword as the search keyword.

20. The non-transitory computer-readable storage medium according to claim 15, wherein the program further causes the at least one processor to:
obtain a historical search statement, and determining a search keyword of the historical search statement and a search demand of the historical search statement;
determine a first category to which the search keyword of the historical search statement belongs and a second category corresponding to the search demand; and
establish the association relationship between the graph entity library of the first category and the graph entity library of the second category.
